(19) United States
(12) Patent Application Publication
(10) Pub. No.: US 2019/0323653 A1
(43) Pub. Date: Oct. 24, 2019

(54) PORTABLE AND EXTENDABLE SUPPORT AND MOUNTING SYSTEM UTILIZING A PLURALITY OF SUPPORT MECHANISMS

(71) Applicant: Jordan B. Pollack, Sudbury, MA (US)

(72) Inventor: Jordan B. Pollack, Sudbury, MA (US)

(21) Appl. No.: 15/960,678

(22) Filed: Apr. 24, 2018

(51) Int. Cl. F16M 11/40; F16M 11/04; G03B 17/56

(52) U.S. Cl. CPC F16M 11/40; F16M 13/04; G03B 17/561; F16M 11/046

(57) ABSTRACT

A portable support and mounting system formed of a mounting component, one or more support members, a base component and middle support member. The portable support and mounting system being adjustable in height. Peripheral devices such as cameras can be mounted to said system for stabilization and other purposes.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### 1. Field of the Invention

The present application relates to the field of mounting support systems, such as tripods, bipods, monopods and so forth.

### 2. Description of the Prior Art

Tripods have typically been composed of collapsible tubes within tubes. The height of the system is dependent upon the height of each section of tube and the number of sections of tubes disposed within each other. The compactness of a tripod is also beholden to the size of the largest and longest section(s) of tubing. An opportunity therefore exists to provide a mounting and support system that can allow for greater compactness and/or greater height adjustments. The present invention seeks to address these opportunities and other deficiencies present with the traditional mounting support systems.

### SUMMARY OF THE INVENTION

Disclosed herein are several embodiments relating to a portable and extendable support and mounting system.

In one embodiment, the support and mounting system comprises a mount provided about a first end of the support and mounting system, the mount having at least one attachment interface wherein alternative devices such as cameras, telescopes and the such could be mounted thereto. In some instances, the attachment interface is a threaded hole. A base is provided about a second end of the support and mounting system wherein at least one support member is extendable between the mount and the base. The support member in several embodiments can be adjustable in height or rather cause a relative increase or decrease in distance between the mount and the base. Further, the support members as illustrated herein can be formed as a rollable tape having a curved cross-section, wherein the curved cross-section provides increased stability for compressive loads.

A middle or reinforcement support can be affixed to the support members so as to provide structural support when in an extended position. This middle support can be both permanently or removably affixed depending on the embodiment.

In some embodiments, the at least one support member is rigidly affixed to the base, while in others it is affixed to the mount.

In an embodiment where the support member is affixed to the base, the base can be further configured to comprise a biased spool contained therein, wherein the at least one support member is configured to retract around the biased spool. This biased spool can have a friction lock or other locking mechanism to inhibit the extension and retraction of the support member or hold it in place at a desired length. It should be understood that the support member can be provided as a bistable tape which can thus be configured to be stable in at least two configurations, i.e. a rolled state and an extended state. In this manner, in the extended configuration support member is designed to support a compressive load that can be applied between the base and the mount.

In yet another embodiment, the support member spans a distance between the mount and the base a plurality of times.

In yet other embodiments, the mount or the base can have channels provided therethrough about which the support member can pass through at least a portion thereof. The channel can be configured to allow either multiple support members to pass through the same channel or a single member to be overlapped onto itself in the same channel. The overlapping of support member can help secure the support member(s) in place.

As mentioned, the portable and extendable support and mounting system can have a plurality of support members. These plurality of support members can be angled with respect to one another or they can be in a substantially parallel position with respect to each other.

In yet another embodiment, a plurality of bases can be provided to receive the plurality support members. This can be in a one-to-one ratio two-to-one ratio or otherwise.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention, wherein:

FIG. 1A illustrates a side view of an exemplary portable and extendable support and mounting system in accordance with various aspects of the present invention;

FIG. 1B illustrates a top cross-sectional view of a support member side adaptable for use in any of the embodiments discussed herein and particularly in the portable and extendable support and mounting system of FIG. 1A in accordance with various aspects of the present invention;

FIG. 1C illustrates a side view having an exemplary mounting interface provided on a mount end of the portable and extendable support and mounting system of FIG. 1A in accordance with various aspects of the present invention;

FIG. 1D illustrates a side perspective view having an exemplary mounting interface provided on a mount end of the portable and extendable support and mounting system of FIG. 1A in accordance with various aspects of the present invention;

FIGS. 2A-B illustrate side assembled and exploded perspective views of an exemplary reinforcement support member being illustrative of various aspects of the present invention

FIGS. 3A-B illustrate various internal portions adaptable for use within the reinforcement support members of FIGS. 2A-B;

FIG. 4 illustrates a side view of an alternative embodiment of an exemplary portable and extendable support and mounting system illustrative of various concepts of the present invention;

FIG. 5 illustrates a perspective view of an exemplary base unit adaptable for use with the portable and extendable support and mounting system of FIG. 4;

FIGS. 6A-B illustrate side and perspective views respectively of the portable and extendable support and mounting system of FIG. 4 utilizing the base unit of FIG. 5 in accordance with various aspects of the present invention;

FIG. 7 illustrates a side view of yet another an alternative embodiment of an exemplary portable and extendable support and mounting system illustrative of various concepts of the present invention;

FIGS. 8A-B illustrate side and perspective views of yet another an alternative embodiment of an exemplary portable and extendable support and mounting system illustrative of various concepts of the present invention;

FIGS. 9A-B illustrate side views of various alternative embodiments of base units adaptable for particular use with the portable and extendable support and mounting system of FIGS. 8A-B being illustrative of various concepts of the present invention; and

FIG. 10 illustrates a side view of yet another an alternative embodiment of an exemplary portable and extendable support and mounting system having support members provided at an angle with respect to one another being illustrative of various concepts of the present invention.

### DETAILED DESCRIPTION OF THE INVENTION

In particular, the present invention relates to a portable and extendable support and mounting system which can be used to stabilize a camera or phone during capture of a photo or video. Previous systems typical systems have utilized multiple rigid legs which can often extend or retract in a telescoping manner. However, these previous systems are often bulky and are severely limited with regard to the degree they collapse and as such can be difficult to place into a bag or pocket.

The present invention seeks to improve the degree of collapsibility and reduce weight by providing a portable and extendable support and mounting system which replaces the legs of a monopod, bipod, or tripod system with an extendable support member acting as the legs or support thereof. In some of the embodiments discussed herein the extendable support members are illustrated as a bistable spring or steel band which can be coiled within or proximal a base or mount unit and thus allows for a virtually complete collapse or retraction of the leg portions of the support and mounting system.

It will be appreciated that support members in this case can be provided a bistable spring steel which can be stable in at least two states. In particular, the support and mounting systems as described herein include a support member which is stable in a coiled state as well as stable in an extended or uncoiled state. Similar bistable springs or tapes and their various states can be seen in slap bracelet systems or common measuring tapes wherein the band or tape can be formed of a resilient material having a curved cross-section which is stable in a straight configuration but can also coil upon itself when certain non-axial loads are applied thereto.

In addition to the bistable version, being stable in two states, such as curled and extended, the support members can also simply be provided as a curved version, wherein the cross-section of the support has a curvature or non-flat profile, a flat profile, where the cross-section is rectangular and two of the faces are parallel or approximately parallel within a few degrees, such as less than 15 degrees in variance, or even other shapes. Each of these versions can be arranged and aligned within the system to provide a compressive load when coupled with the mount, the middle support and in some embodiments the base. Other combinations of the mount and base with the support therebetween are also contemplated

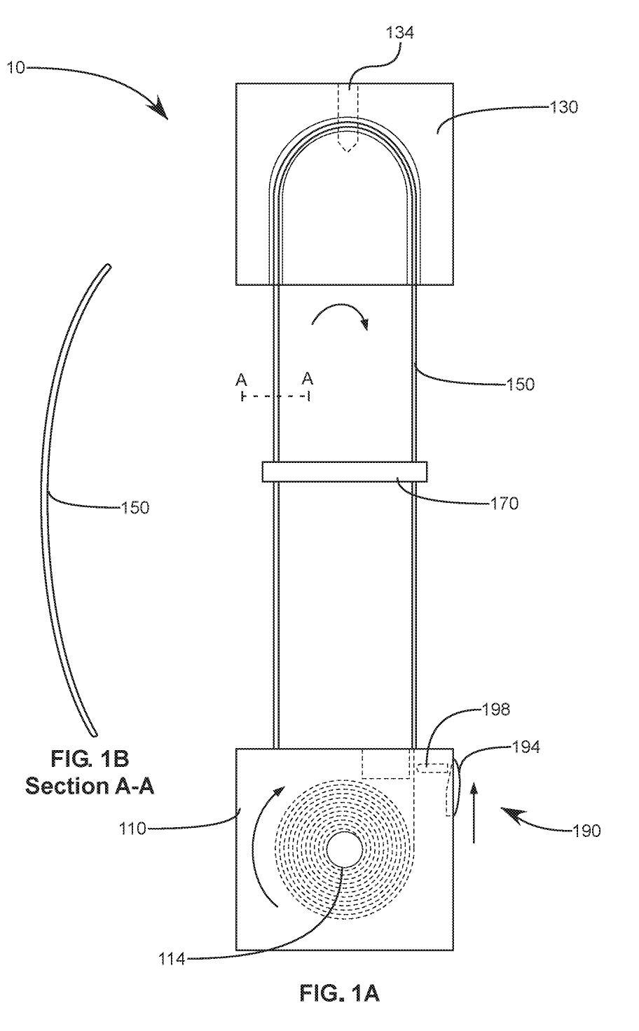

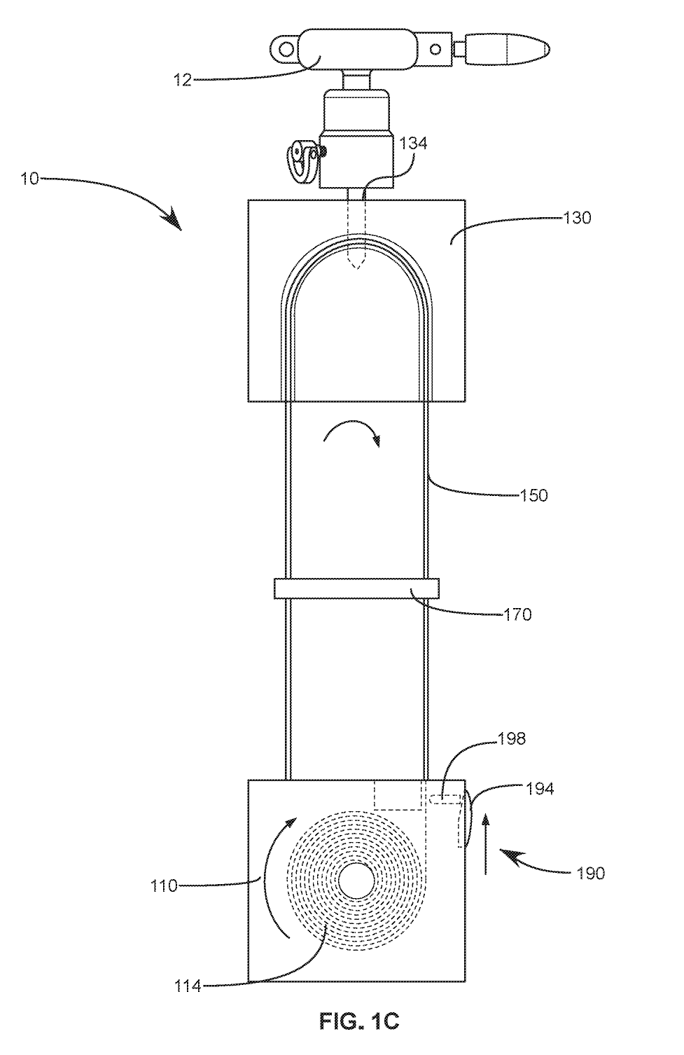

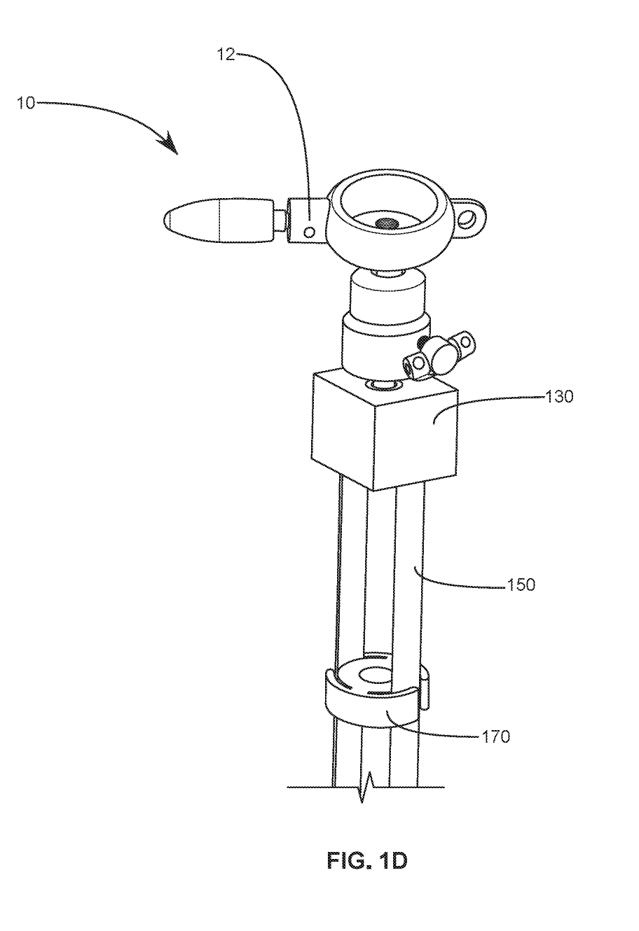

As such various embodiments of portable and extendable support and mounting systems and components adaptable for use therein are illustrated in FIGS. 1-10 which allow for springs or support members can be extended from the mount or base portions of the system and thus facilitate the support and stabilization of an electronic unit affixed to the mount portion thereof. In particular, when extended, the support members can transfer an axial compressive force to the base unit, which can be placed on a stable surface.

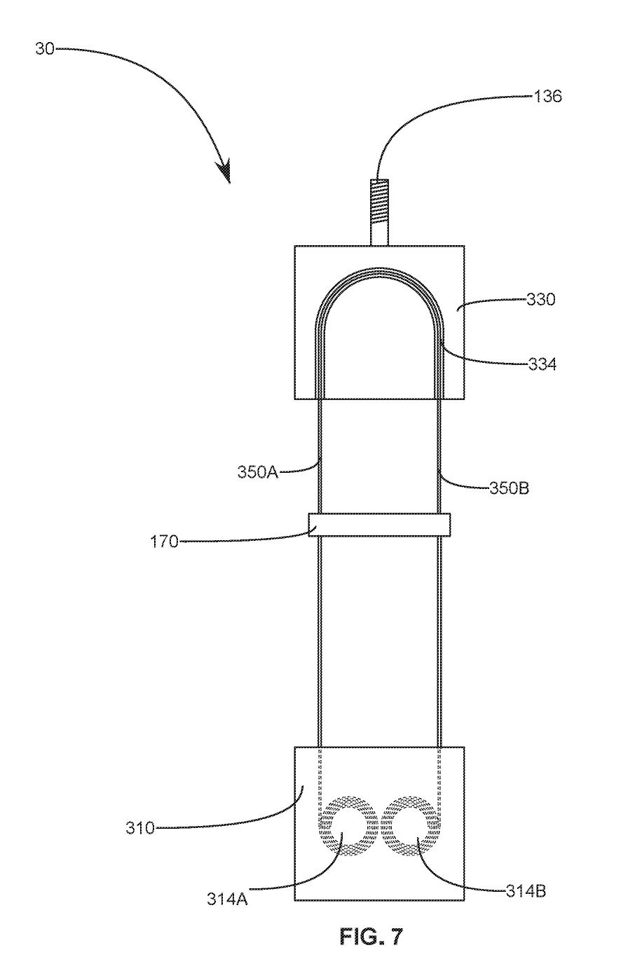

In particular FIGS. 1A-D illustrate a first exemplary embodiment of a portable and extendable support and mounting system 10 which includes a mount 130 provided about a first end of the portable and extendable support and mounting system 10. It will then be understood that the mount 130 can include at least one attachment interface 134 configured to receive an associated interface for mounting a desired electronic thereon. While the attachment interface 134 is shown herein as a female threaded portion, said interface can also be provided as an adhesive, male threaded stud 136, as seen in FIG. 7, strap, hook and loop fastening component, or any other attachment mechanism as will be appreciated by those having skill in the art.

This embodiment also includes a base 110 which can have a support member 150 which extends therefrom. In this embodiment the support member 150 can be retained in a first stable and coiled state within the base 110 on a spring-loaded spool 114. The spring-loaded spool 114 in this embodiment can be biased to pull the support member 150 into a retracted state.

This embodiment also illustrates how a single support member 150 can then be pulled or extended from the base 110, extend a desired distance, pass through the mount 130, and then extend back to a second point on the base 110 so as to form a loop, and thus provide two parallel support axes.

The desired extended or relative distance between the base 110 and the mount 130 can then be retained through use of a locking mechanism 190 provided proximal the spool 114 about the base 110. The locking mechanism 190 illustrated here is a friction lock mechanism which can include a slide or button 194 having a sloped interior surface wherein translation of the button 194 can push a friction or lock member 198 into an interfering relationship with an opposing surface within the base 110 and thus pinch or lock the support member 150 therebetween thus preventing further extension or retraction thereof. It will then be further understood that while a friction lock is illustrated herein, the locking mechanism can also include notches, apertures, holes, etc provided in the support member wherein a lock member 198 can pass through said hole or notch and positively lock further translation of retraction of the support member.

It will be further understood that FIG. 1B illustrates a close-up top or axial cross-sectional view of the support member 150, which illustrates a curved cross-sectional shape of the support member 150. In the embodiments discussed herein, the curved cross-section allows for a stable straight or extended state which is capable of receiving and supporting an axial load; but can then be coiled in response to a moment or inward torque which will allow the support member 150 to coil about the concave surface with the concave surface facing radially inward within the coil. In this embodiment the two opposing faces of the support member forms an effective partially enclosed area, and the multiple passes thereof provide additional stability so as to support larger or heavier camera or recording devices. This curved cross-sectional area provides additional stability which resists the tendency to buckle the when a compressive load is placed thereon.

It will then be understood that in the embodiments of FIG. 1A-D the support member 150 is arranged so that the concave surface is facing radially inwardly toward a central axis thereof, and inwardly toward the coil 114 within the base 110.

It has also then been recognized that as the relative distance between the base 110 and the mount 130 increases, and thus the distance that the support member 150 is required to span, that the stability of the support member decreases as the distance grows. In order to mitigate this decrease in stability a middle support or reinforcement member 170 can be provided along the spanning distance of the support member 150 which can retain the concave shape thereof and relative spacing so as to increase the stability of the support member along its extended length.

The middle support as mentioned above helps to prevent the support members from buckling when a given force is applied thereto. The middle support can also help provide stability when a non-vertical force is introduced, such as a horizontal force, and provides a moment force to counteract the horizontal force. This in turns prevents bending or buckling. Multiple middle supports can be positioned along the length of the support member(s) depending on the given length of the support member. Ideally, the middle supports are designed to be lightweight so that most of the force or load on the system is transferred through the support members.

FIGS. 1C-D illustrate perspective views of various portions of the portable and extendable support and mounting system 10 as that shown in FIG. 1A, except this view includes an intermediate mount assembly 12, such as a lockable ball joint configured to receive the electronic component thereon.

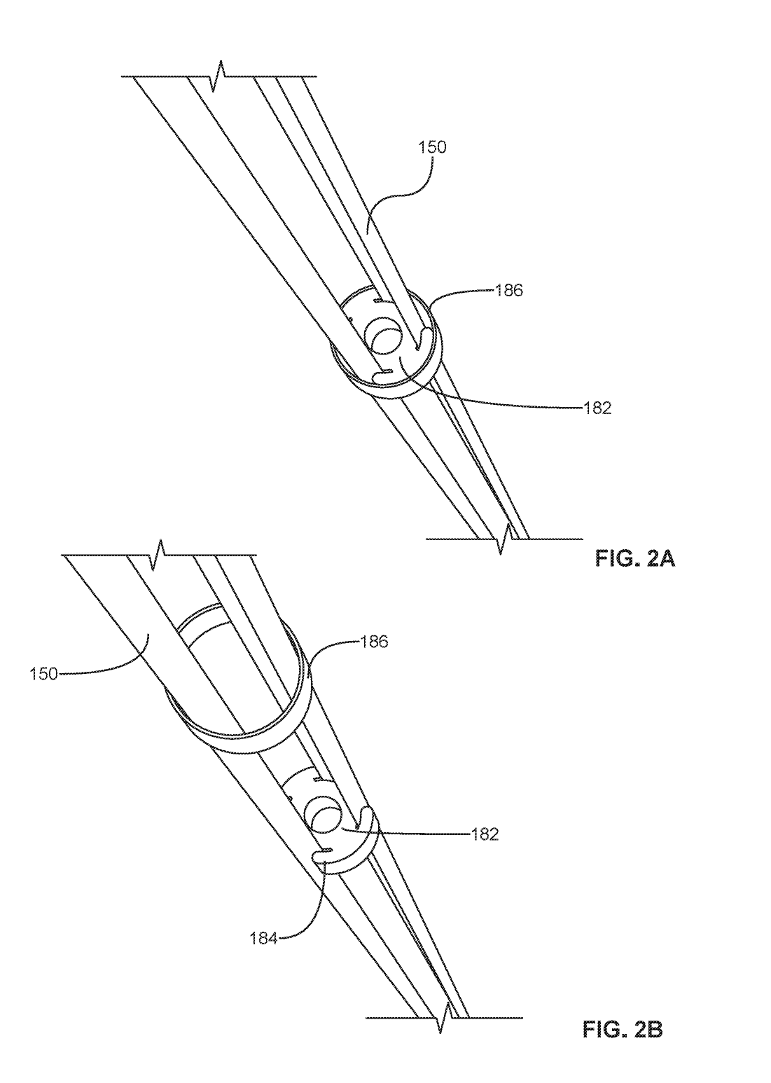

As illustrated in FIGS. 2A-B the reinforcement member 170 can include one or more curved slots or channels 174 provided therein having support surfaces 178 provided therein which correspond in shape to the curvature of the support member 150 in the extended state. This curved support surfaces 178 can then retain the support member in the proper orientation, and spacing, so as to ensure the support member is retained in a stable extended state. It will then be understood that a plurality of said reinforcement members 170 can be provided based on a recognized need and proposed desired length or distance between the base 110 and the mount 130.

The reinforcement member 170 can include an interior portion 182 and a lock or retaining outer ring 186. However, in some embodiments the retaining outer ring 186 can also be omitted therefrom as the interior portion 182 can include arms 184 which also extend around a portion of the convex outer surface of the support member 150. In some configurations an adhesive, hook and loop material, such as VELCRO, or other such attachment mechanisms can be disposed on the inner surface of the outer ring 186 and the outer surface of the interior portion 182 to assist in securing these components together. These attachment mechanisms although not shown, are readily known in the art and as just described.

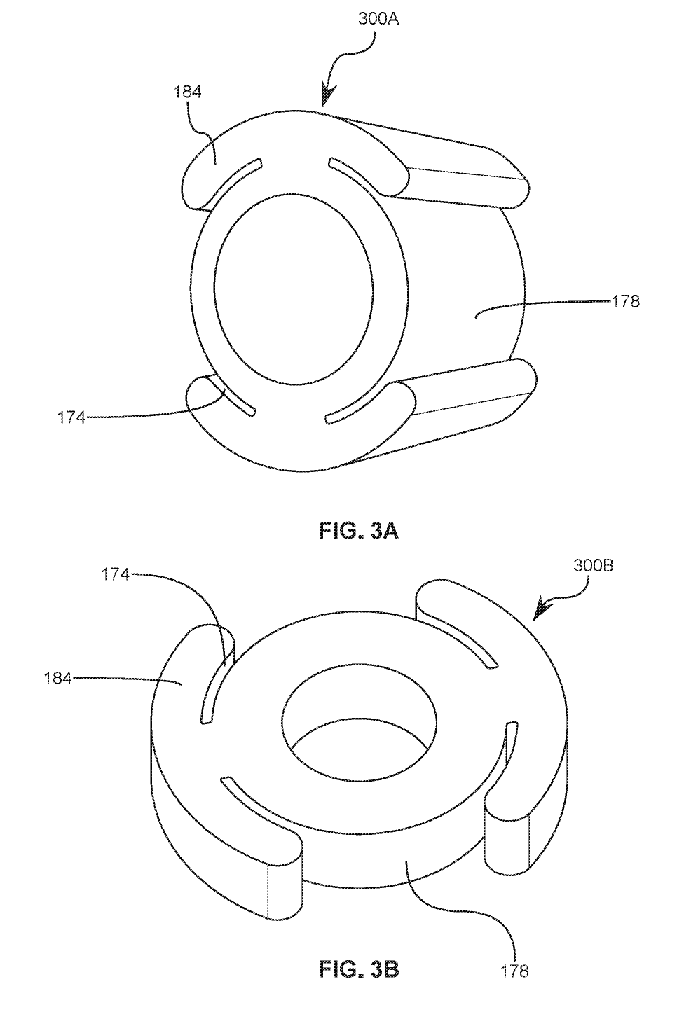

FIGS. 3A-B illustrate additional reinforcement members 300A-B, showing the how the height can vary along with varying the curvature of the surfaces 178, arms 184, and channels or slots 174 depending upon the given application. The aperture in the center can also be modified or be non-existent as well.

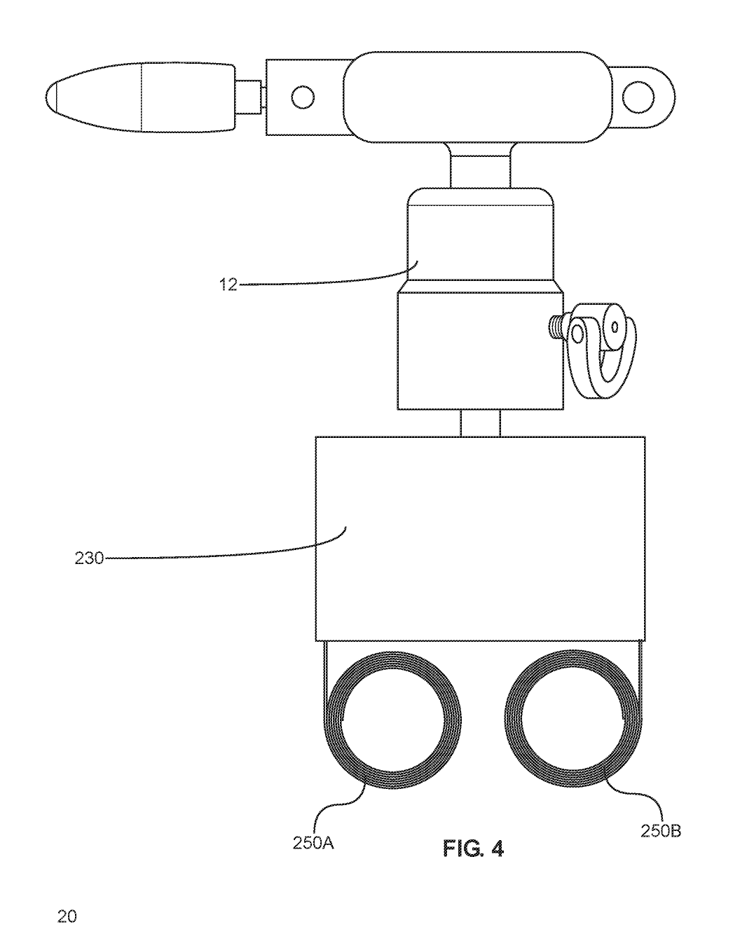

FIG. 4 illustrates an alternative embodiment of a portable and extendable support and mounting system 20 which illustrates an alternative mount 230, having an intermediate mount 12 provided thereon. This embodiment differs in that it includes two support members 250A and 250B which can extend from opposing sides of the mount 230. It will be understood that the support members 250A and 250B have concave surfaces facing one another so as to facilitate the coiled state configuration as shown, wherein the respective coils coil radially inwardly toward the center of the mount 230. It will be understood that in this embodiment, due to the bistable nature of the support members 250A and 250B that no spool is required to enter this state and be substantially retained therein.

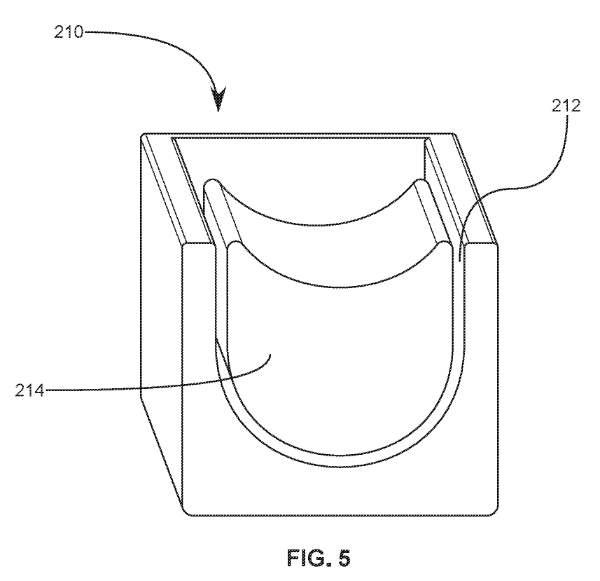

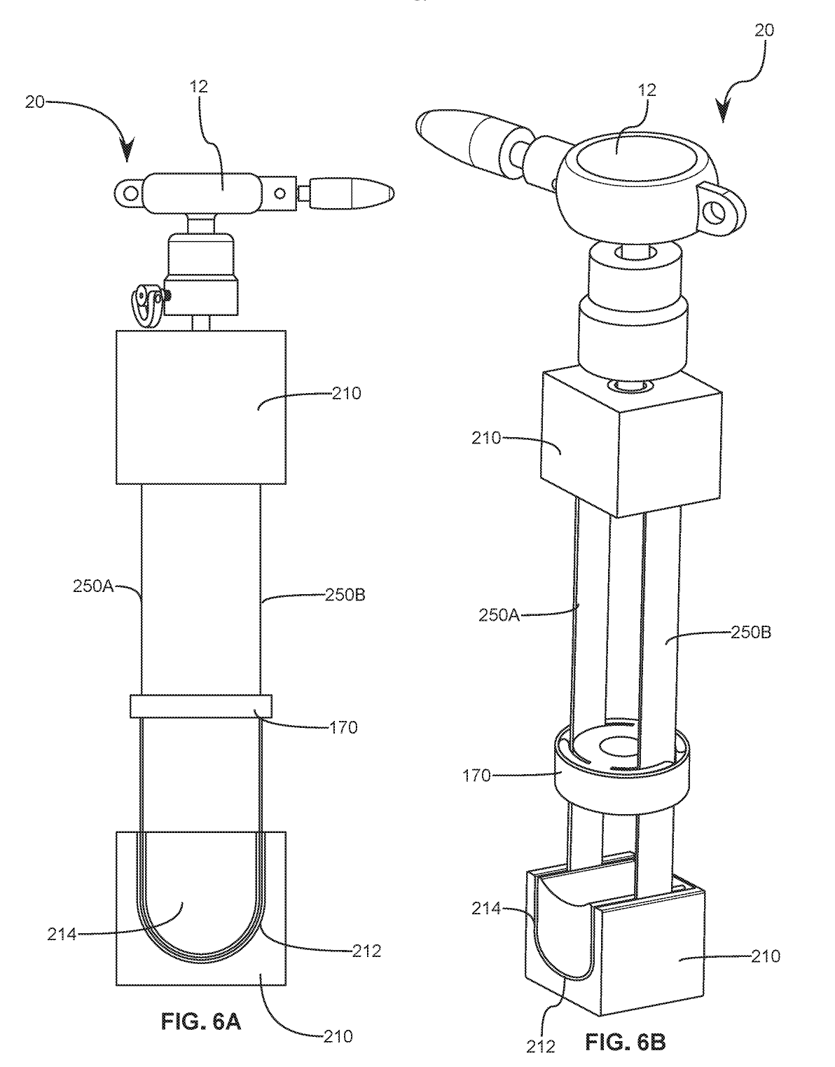

FIG. 5 illustrates an alternative base 210 configured for use with the embodiment illustrated in FIG. 4. Further, FIGS. 6A-B illustrate how the base of FIG. 5 can be utilized in conjunction with the portable and extendable support and mounting system 20. This base 210 includes a channel 212 being configured to receive the support members 250A and 250B at respective ends. In some embodiments the channel 212 can be configured to include clearance so as to allow the support members to overlap within the channel, and in some instances to continue to wrap around or coil around a central portion 214 of this alternative base 210. However, in some instances, this embodiment can be utilized in situations where the base 210 can be omitted altogether, particularly when the support members 250 are short and can be rested on a linear or planar surface wherein the axial compressive force provided thereon can be supported without becoming unstable in an extended state thereof.

Alternatively, FIGS. 6A-B illustrate the use of the alternative portable and extendable support and mounting system 20 as illustrated in FIG. 4 as provided in an extended state which is illustrated as sufficiently extended such that a reinforcement member 170 can be utilized therewith. It will be further understood that the support members 250A and 250B can be provided having any number of lengths so as to meet the demands of a particular user.

FIG. 7 illustrates a side view of yet another alternative portable and extendable support and mounting system 30 which utilizes an alternative base 310 and an alternative mount 330. In this embodiment first and second support members 350A and 350B respectively can extend from respective spools 314A and 314B respectively which are located within the base 310. In this embodiment, the support members can then be extended and caused to pass through a channel 334 provided in the mount. This channel 334 can also have appropriate dimensions so as to allow for overlapping of the support members 350A and 350B over one another within the channel 334.

It will be understood that the spools 314A-B can also be spring loaded or biased inwardly into the spooled state, wherein the base 310 can also be provided with similar locking mechanisms, as discussed with respect to the embodiment shown in FIG. 1A-D, so as to fix an extended length or position of the relative support members. In some such cases more than one such lock can be provided.

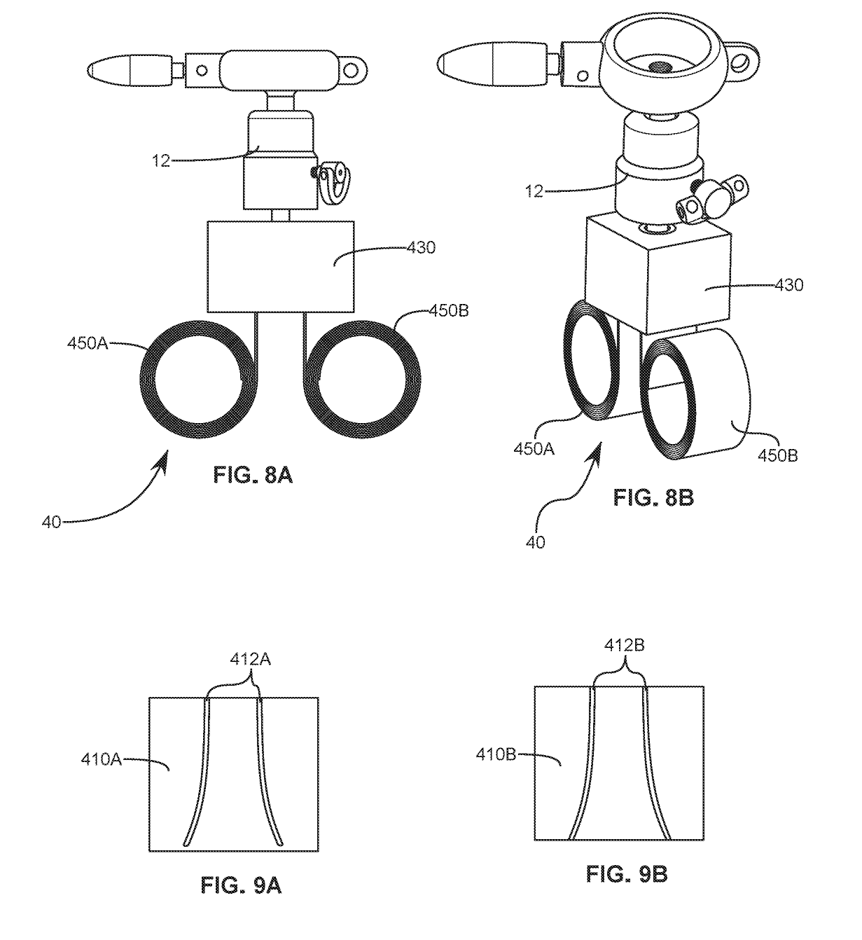

FIGS. 8A-B illustrates yet another alternative embodiment of a portable and extendable support and mounting system 40 which illustrates an alternative mount 430, having an intermediate mount 12 provided thereon. This embodiment differs in that it includes two support members 450A and 450B which can extend from opposing sides of the mount 230 but have the concave surfaces thereof facing radially outward from the central axis thereof. It will be understood that in this embodiment, due to the nature of the support members 450A and 450B that no spool is required to enter this state and be substantially retained therein.

However, similar to the embodiments discussed above, base units 410A and 410B as illustrated in FIGS. 9A-B can also be used with the embodiments of FIGS. 8A-B. These base units also include channels 412A-B provided therethrough configured to receive the support members 450A-B respectively. In particular, the channel 412A can terminate within the base unit 410A such that the use provides a predetermined height based on the length of the support members themselves. However, the base unit 410B can have channels 412B which extend through an opposing surface such that the support members can pass therethrough and can even coil around outside of the base member on said opposing side such that the base unit can be slid along the length of the support members 450A-B so as to have a customizable height or distance. In some embodiments a locking mechanism, as discussed above, can also be provided to this base 410B.

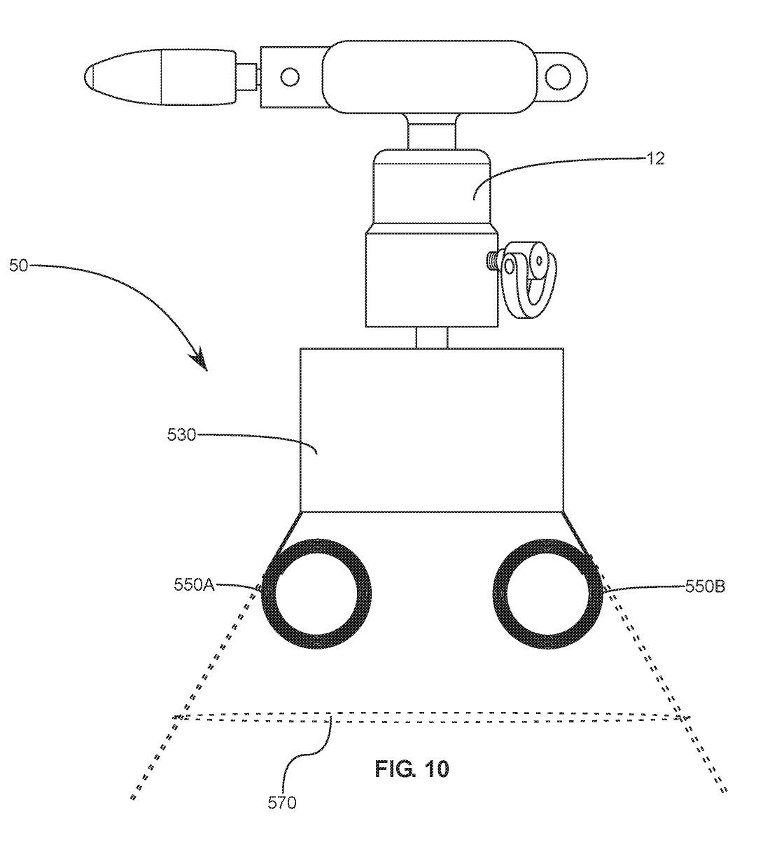

FIG. 10 illustrates yet another alternative embodiment of a portable and extendable support and mounting system 50 which illustrates an alternative mount 530, having an intermediate mount 12 provided thereon. This embodiment differs in that it includes two support members 550A and 550B which can extend from opposing sides of the mount 530 but have the concave surfaces thereof facing radially inward toward the central axis thereof but instead extend away from the mount 530 at an angle with respect to one another. It will be understood that in this embodiment, due to the bistable nature of the support members 550A and 550B that no spool is required to enter this state and be substantially retained therein. Further, in this embodiment no base is required, however a base having a corresponding singular curved channel can be provided which can be place over an end thereof. Further, a reinforcement member 570 can be provided so as to stabilize the support members at increased lengths. In some instances, it is required to resize the reinforcement member 570 such that it adequately spans the distance, and it will be understood that such reinforcement members can be configured to be placed at predetermined distances so as to maintain a proper angle between the support members.

In some instances, the reinforcement member 570 could be provide with a telescoping central portion such that it can be placed at any length or distance and appropriately adjusted thereto.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

Additionally, any features, structures, components, method steps which are discussed in reference to any one of the aforementioned embodiments are readily adaptable for use into and with any features of the other alternative embodiments discussed therein, with the understanding that one of ordinary skill in the art will be capable of assessing the ability of the various embodiments disclosed and be capable of making such adaptations.

What is claimed:

1. A portable mounting system, the system comprising:
a mount provided about a first end of the portable mounting system, the mount having at least one attachment interface;
a base provided about a second end of the portable mounting system;
a middle support member; and
one or more support members spanning from a plurality of points between the mount, the middle support member, and the base, the one or more support members being configured to support a compressive load.

2. The portable mounting system of claim 1, further comprising a spool contained within the base, wherein the at least one support member is configured to retract around the spool.

3. The portable mounting system of claim 2, further comprising a locking mechanism provided about the base being configured to retain the at least one support member at a desired length.

4. The portable mounting system of claim 1, further comprising a plurality of support members.

5. The portable mounting system of claim 1, wherein the at least one support member is rigidly affixed to the base at a first end, extends through a channel provided in the mount, and returns to the base at a second end.

6. The portable mounting system of claim 1, wherein the middle support member includes one or more receiving channels formed therein corresponding to each support member, each receiving channel having a curved cross-section corresponding in shape to the curved cross-section of the support member in the extended state.

7. A portable support and mounting system, the support and mounting system comprising:
a mount provided about a first end of the support and mounting system, the mount having at least one attachment interface;
a base provided about a second end of the support and mounting system; and
at least one support member, the support member having a curved cross-section in an extended state, the support member being extendable between the mount and the base, being configured to adjust a relative distance between the mount and the base.

8. The portable support and mounting system of claim 7, wherein the at least one support member is rigidly affixed to the base.

9. The portable support and mounting system of claim 7, wherein the at least one support member is rigidly affixed to the mount.

10. The portable support and mounting system of claim 9, further comprising a spool contained within the base, wherein the at least one support member is configured to retract around the spool.

11. The portable support and mounting system of claim 10, further comprising a locking mechanism provided about the base being configured to retain the at least one support member at a desired length.

12. The portable support and mounting system of claim 7, further comprising a biased spool contained within the base, wherein the at least one support member is configured to retract around the biased spool.

13. The portable support and mounting system of claim 7, further comprising a middle support member provided between the mount and the base along the length of the at least one support member.

14. The portable support and mounting system of claim 13, wherein the middle support member includes one or more receiving channels formed therein corresponding to each support member, each receiving channel having a curved cross-section corresponding in shape to the curved cross-section of the support member in the extended state.

15. The portable support and mounting system of claim 7, wherein the at least one support member spans a distance between the mount and the base a plurality of times.

16. The portable support and mounting system of claim 7, wherein the at least one support member is rigidly affixed to the base at a first end, extends through a channel provided in the mount, and returns to the base at a second end.

17. The portable support and mounting system of claim 7, further comprising a middle support configured to provide structural support to the at least one support member while in the extended state.

18. The portable support and mounting system of claim 7, further comprising a plurality of support members.

19. The portable support and mounting system of claim 18, wherein each of the plurality of support members are angled with respect to one another.

20. A portable and extendable support and mounting system, the support and mounting system comprising:
a mount provided about a first end of the support and mounting system, the mount having at least one attachment interface;
a base provided about a second end of the support and mounting system;
a plurality of support members having curved cross-sections, the plurality of support members extending between the mount and the base;
a middle support configured to provide structural support to the plurality of support members while in an extended state, the mount having a plurality of channels formed therein, each channel having a curved cross-section corresponding in shape to the curved cross-section of the support members; and
wherein the mount provides a first stability point, the base provides a second stability point, and the middle support providing a third stability point for each of the support members.
